(19) United States
(12) Patent Application Publication
(10) Pub. No.: US 2005/0096166 A1
(43) Pub. Date: May 5, 2005

(54) Hydraulic tensioner

(76) Inventors: Naoki Wakabayashi, Osaka (JP); Osamu Yoshida, Osaka (JP)

Correspondence Address: HOWSON AND HOWSON;ONE SPRING HOUSE CORPORATION CENTER, BOX 457, 321 NORRISTOWN ROAD, SPRING HOUSE, PA, 19477, US

(21) Appl. No.: 10/935,611

(22) Filed: Sep. 7, 2004

(30) Foreign Application Priority Data
Oct. 30, 2003 (JP) 2003-370728

(51) Int. Cl. F16H 7/08; F16H 7/22

(52) U.S. Cl. 474/110; 474/101; 474/109; 474/111

(57) ABSTRACT

A hydraulic tensioner comprises a housing, a downwardly projecting plunger engageable with a power transmission chain, and a cylindrical check valve unit. The check valve unit delivers oil under pressure from an oil supply passage to a high pressure oil chamber formed by the housing and the plunger, but blocks reverse flow of oil. The check valve unit fits into the housing, and has a groove formed in its exterior surface for evacuating air bubbles mixed with the oil in the high pressure oil chamber R to oil supply passage.

### FIELD OF THE INVENTION

This invention relates to a hydraulic tensioner for applying tension to a transmission medium such as a timing belt, a timing chain or the like, used to drive one or more camshafts in a vehicle engine.

### BACKGROUND OF THE INVENTION

Hydraulic tensioners have been widely used for suppressing vibration and maintaining proper tension in a timing chain For example, Japanese laid-open patent publication no. 2002-364720 describes an example of a conventional chain tensioner in which a plunger is biased by a spring so that it projects from a cylindrical chamber formed in a housing. The plunger and the housing cooperate to form a high pressure oil chamber behind the plunger. The housing is provided with a check valve allowing entry of oil into the high pressure oil chamber from an oil supply, but blocking reverse flow of oil. The housing has a hole communicating with a high pressure oil chamber, and a plug composed of an air-permeable material, such as a sintered metal or the like, is press-fit in the hole. When the pressure in the high pressure oil chamber increases, air bubbles retained in the pressure chamber are evacuated to the outside through the air-permeable plug.

The production cost of the above-described tensioner is relatively high because of the requirement for an additional hole in the housing and the need for pressing a plug composed of an air permeable material into hole. In addition, the space required for the additional hole and plug, increases the overall size of the tensioner.

Furthermore, if the tensioner disclosed in Japanese laid-open patent publication no. 2002-364720 is arranged so that it presses downward on a timing chain or other transmission medium, air bubbles in the high pressure oil chamber are evacuated to the oil supply side of the check valve as the check valve is opened by gravity. However, the bubbles are not evacuated to the outside of the housing. As a result, the oil, which should be under a high pressure in the oil chamber, remains mixed with air bubbles, and behaves with a sponge-like effect, preventing proper tension from being applied to the timing chain, and allowing the chain to vibrate and generate backlash noises.

An object of the invention, therefore, is to solve the above-described problems, and to provide a hydraulic tensioner which in which air bubbles mixed with oil in the high pressure chamber can be reliably removed by a simple evacuation structure so that backlash noise can be suppressed when the tensioner is arranged so that its plunger presses in a downward direction on a traveling, flexible transmission medium.

### SUMMARY OF THE INVENTION

The hydraulic tensioner according to the invention comprises a housing having a plunger-accommodating hole, and a plunger slidable in the plunger-accommodating hole. The plunger has a closed lower end protruding from the hole in a downward direction for applying tension to a traveling power transmission medium such as a timing chain, and an open upper end within the hole. The plunger and the plunger-accommodating hole cooperate to form a high pressure oil chamber. A plunger-biasing spring in the high pressure oil chamber biases the plunger in the protruding direction. An oil supply passage in the housing communicates with the high pressure oil chamber for delivery of oil under pressure from an oil supply to the high pressure oil chamber. A check valve unit, disposed between the oil supply passage and the high pressure oil chamber, permits oil to flow from the oil supply passage into the high pressure oil chamber but blocks reverse flow of oil from the high pressure oil chamber to the oil supply passage. The check valve unit comprises a ball seat having an opening communicating with the oil supply passage, a check ball movable into contact with the ball seat to close the ball seat opening, and away from said ball seat to allow flow of oil through the opening into the high pressure oil chamber. A ball-biasing spring urges the check ball toward the ball seat, and a retainer, positions and supports the ball-biasing spring, and limits movement of the check ball away from said ball seat. The retainer has an interior space containing the ball and the ball-biasing spring, and the ball seat fits into the interior space of the retainer. The retainer also has an outer surface with a first end facing the high pressure oil chamber and a second end, below the level of the second end, and facing the oil supply passage. An evacuation groove, formed in the outer surface of the retainer, extends from the first end to the second end of the outer surface of the retainer, for releasing air bubbles from the high pressure oil chamber to the oil supply passage.

Air bubbles mixed with the oil in the high pressure chamber side are moved upward by a buoyant force, and pass upward through the evacuation groove in the outer surface of the retainer. The air bubbles are thus reliably evacuated through the oil supply passage even when the tensioner is arranged so that its plunger presses downward against a traveling transmission medium. Backlash noises due to the sponge-like effect of air bubbles mixed with the oil in the high pressure oil chamber, which occur when a conventional tensioner is arranged to press downward on a transmission medium, are avoided, and proper tension is reliably applied to the transmission medium.

Furthermore, since the evacuation groove is provided in the outer surface of the retainer, the plug and plug-receiving hole of the conventional tensioner are eliminated, and it is unnecessary to increase the size of the tensioner to provide space for these parts. The evacuation structure is simple, the evacuation groove in the retainer can be easily machined.

Furthermore, since the check valve unit is a simplified integral structure, comprising a ball seat, a check ball, a ball-biasing spring and a retainer, assembly of the check valve unit and incorporation of the unit into the tensioner can be carried out easily and accurately, and the production cost of the retainer can be significantly reduced.

### BRIEF DESCRIPTION OF THE DRAWINGS

FIG. 1 is a schematic elevational view of a timing transmission in a dual overhead cam V-type engine, in which a hydraulic tensioner according to the invention is incorporated;

FIG. 2 is a cross-sectional view of a hydraulic tensioner in accordance with the invention.

FIG. 3 is an enlarged perspective view, partly in section, showing the check valve unit; and

FIG. 4 is a detailed schematic view illustrating how bubbles are evacuated from the high pressure chamber of the tensioner of FIG. 2.

### DETAILED DESCRIPTION OF THE PREFERRED EMBODIMENTS

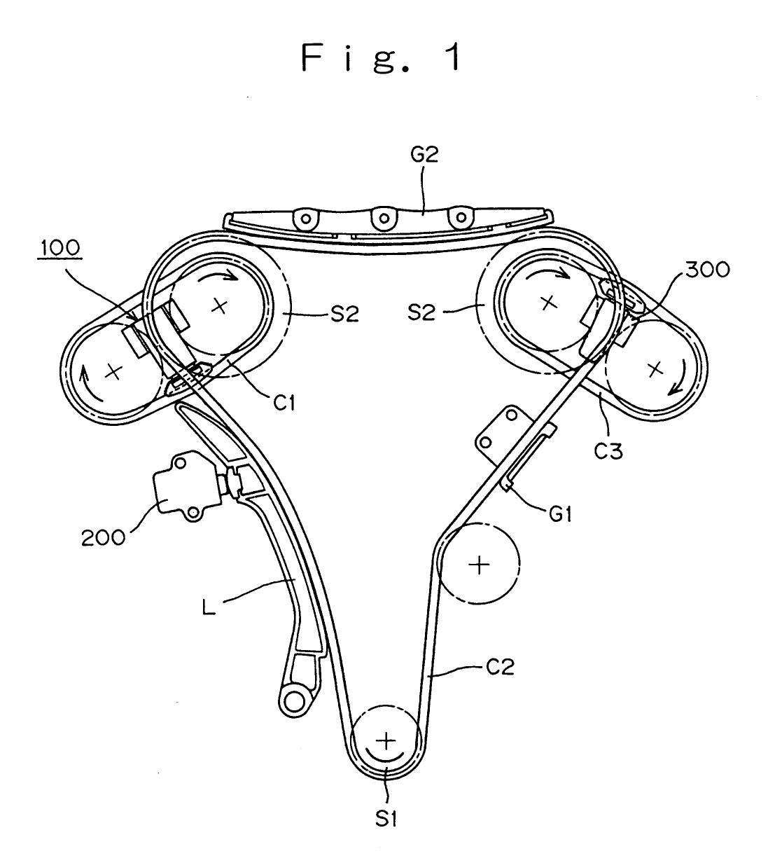

In FIG. 1, hydraulic tensioner 100 is a tensioner in accordance with this invention. The tensioner applies tension to a timing chain C1, which is one of several transmission media in a V-DOHC (V-type, double overhead cam) engine. In this engine, a main timing chain C2 meshes with a crankshaft sprocket S1, and delivers rotating power to camshaft sprockets S2 on opposite sides of the engine. Chains C1 and C3, in turn, deliver rotating power to the other camshafts. Thus, as shown in FIG. 1, chain C1 is engaged with sprockets on a pair of camshafts on one side of the engine, one of which is driven by the crankshaft through sprocket S1, chain C2, and sprocket S2. The tensioner housing is attached to the engine body, and the tensioner applies tension to the slack side of chain C1 by engagement with the inner peripheral side of the chain.

Tensioner 200, which applies tension to the slack side of chain C2 as it travels away from the crankshaft sprocket S1, is different type of tensioner from the hydraulic tensioner 100. Tensioner 200 applies tension to the chain C2 through a pivoted lever L. Fixed guides G1 and G2 guide the stretched portion of chain C2 between sprockets S2, and the portion of chain C2 traveling from the right-hand sprocket S2 toward the crankshaft sprocket S1. Tensioner 300, which applies tension to the slack side of chain C3 on the inner periphery of the chain, is different from tensioner 100, and, because its plunger projects upward, air bubbles are released as oil leaks past the plunger. Therefore, the “sponge” effect resulting from the accumulation of air bubbles, which occurs in the case of a tensioner having a downwardly projecting plunger, is not a problem in tensioner 300.

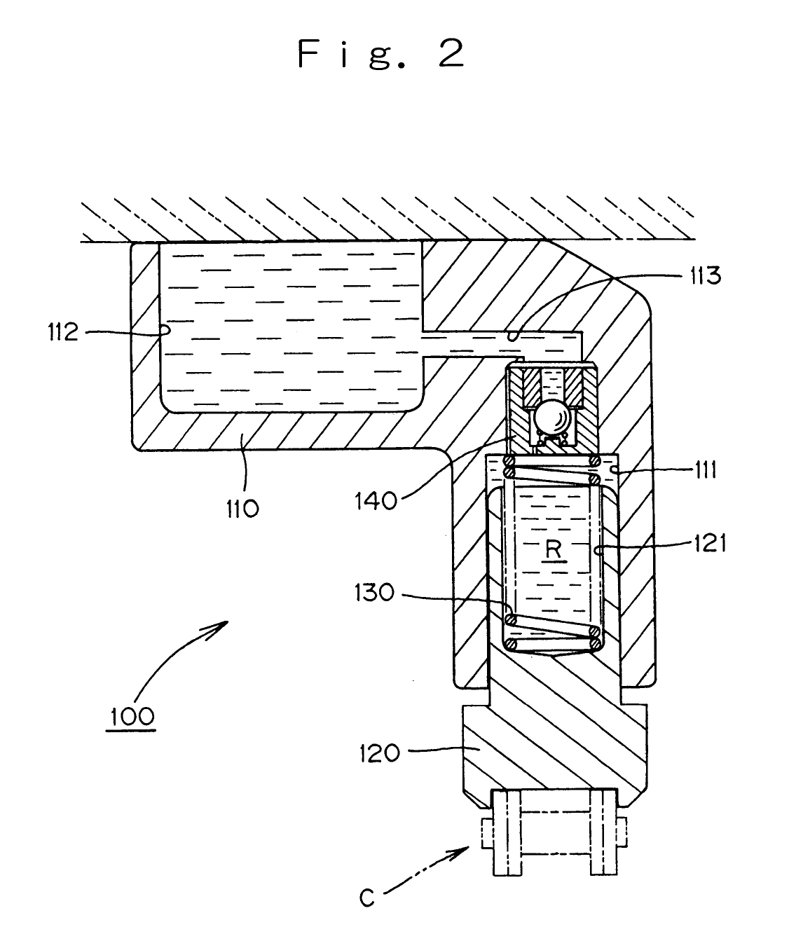

As shown in FIG. 2, the housing 110 of tensioner 100 has a plunger-accommodating hole 111, in which a cylindrical plunger 120 fits slidably. The plunger has a closed lower end which projects outside the plunger-accommodating hole, and slidably engages a timing chain C. The upper end of the plunger is open.

The hollow interior 121 of the plunger receives a plunger biasing spring 130, which urges the plunger 120 in the protruding direction. The plunger and housing together cooperate to form a high pressure oil chamber R, in which the spring 130 is accommodated.

The housing 110 has an oil supply passage 113, through which oil is supplied from a reservoir 112, also formed in the housing. The reservoir, in turn, receives oil under pressure from an external oil supply (not shown). A check valve unit 140 is provided between the oil supply passage 113 and the high pressure chamber R. The check valve unit allows oil to flow down from passage 113 to the high pressure oil chamber R, but blocks reverse flow of oil from chamber R to passage 113. A deaerating hole (not shown), is provided in reservoir 112 for evacuating air bubbles mixed with the oil supplied from the exterior oil supply and temporarily stored in the reservoir. The position of the deaerating hole depends on the form of the tensioner and its relationship to the engine.

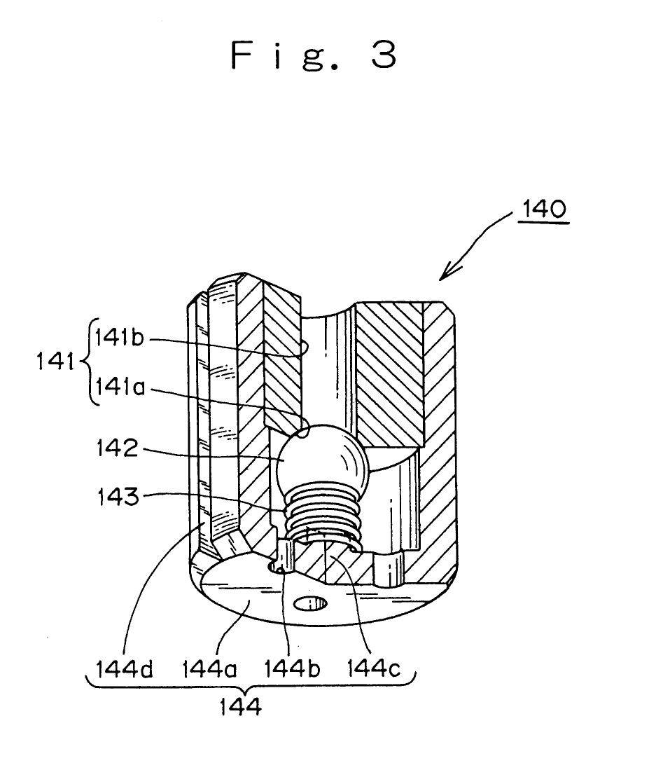

As shown in FIG. 3, the check valve unit 140 comprises a cylindrical ball seat 141, which has a central passage 141b for communicating with the oil supply passage 113. A check ball 142, prevents reverse flow of oil by contact with a seating surface 141b, and is movable away from the seating surface to allow forward flow of oil from the supply to the high pressure oil chamber of the tensioner housing. A ball-biasing spring 143 urges the check ball 142 toward the ball seating surface 141a. The ball seat 141 is press-fit into a retainer 144, which has a substantially cylindrical exterior, and an end wall at its lower end. The check ball and the ball-biasing spring are disposed in a space provide inside the retainer 144, between the ball seat and the end wall. The end wall has a central projection 144c, which fits into the spring 143 to hold the spring in a centered position. The projection also limits movement of the ball 142 away from the ball seat.

The end wall of the retainer 144 has a flat outer surface 144a facing the high pressure chamber R. Three holes 144b, are provided in end wall for allowing oil from the supply passage 113 to flow downward into the high pressure chamber R.

The outer circumferential surface of the retainer 144 is provided with an evacuation groove 144d, which extends from one end of the retainer to the other end, for evacuating air bubbles mixed with the oil in the high pressure chamber R, by allowing the bubbles side to float through the groove to the oil supply passage 113.

When an impact force acts on the tip of the plunger 120 as a result of a change in tension in the timing chain C (FIG. 2), the plunger 120 is rapidly pressed in the retracting direction against the force exerted by the plunger biasing spring 130. The pressure of the oil in the high pressure chamber R is increased. However, the check ball 142 in the check valve unit 140 is held against the seating surface 141a of the ball seat 141 by the ball biasing spring 143, so that reverse flow of oil, from the high pressure chamber R to the oil supply passage through passage 141b (FIG. 3) of the ball seat 141, is blocked.

As a result of the increase in the oil pressure in the high-pressure chamber R, some of the oil leaks through a small gap between the outer peripheral surface of the plunger 120 and the inner peripheral surface of the plunger-accommodating hole 111, and flows to the outside of the housing 110. Because of the viscosity of the oil, its leakage past the plunger exerts a damping effect on the plunger, and vibration of the plunger due to the impact force is rapidly attenuated.

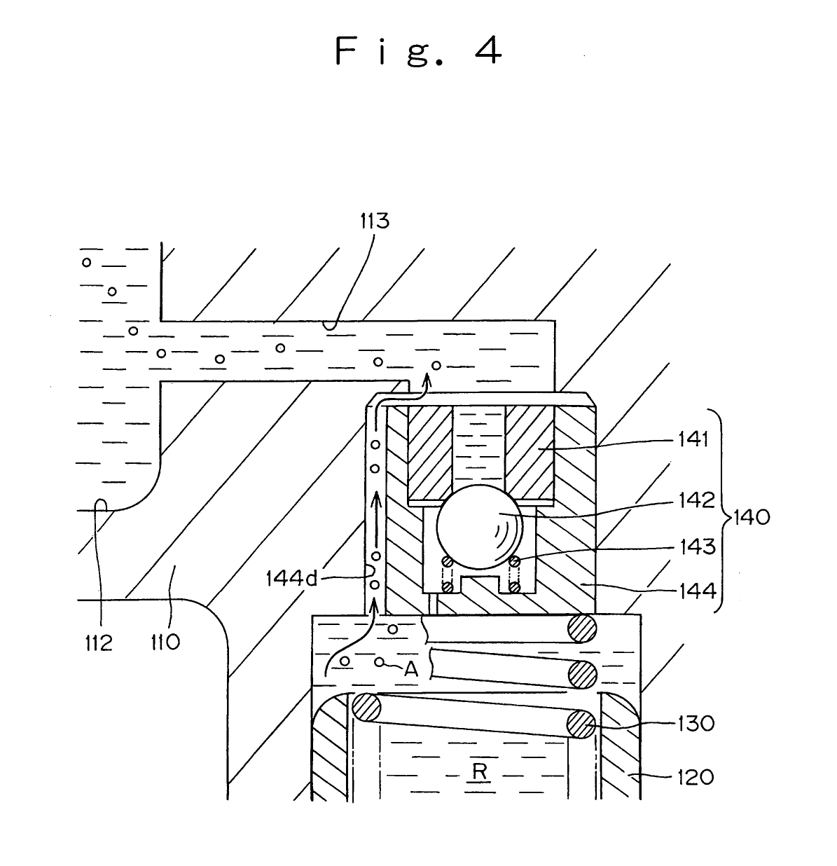

When the hydraulic tensioner 100 is disposed so that its plunger presses in a downward direction on the timing chain C1 as shown in FIG. 1, even if air bubbles are mixed with the oil in the high pressure chamber R as a result of the presence of air in the oil supply when the engine is started, a buoyant force exerted by the oil on the air bubbles causes the bubbles to rise in the high pressure chamber. As shown in FIG. 4, the bubbles A pass into groove 144d, and are reliably evacuated to the oil supply passage 113, thereby avoiding the sponge-like effect described above.

Backlash noises due the sponge-like behavior of oil containing bubbles, which are apt to occur when a conventional tensioner is arranged so that its plunger presses downward against a chain, are suppressed so that proper tension can be applied.

The bubbles in the high pressure oil chamber are reliably evacuated by a simple evacuation structure composed of an evacuation groove 144d in the outer circumferential surface of the retainer 144, which can be easily machined.

Furthermore, since the check valve unit 140 is an integral structure, including the ball seat 141, the check ball 142, the ball-biasing spring 143 and the retainer 144, assembly of the unit, and incorporation of the unit into the tensioner housing 110 can be carried out easily and with accuracy. Accordingly, the production cost of the tensioner can be significantly reduced.

The advantages of the invention can be realized in various modified versions of the hydraulic tensioner described above. For example, other forms of hydraulic tensioners can be used, such as a hydraulic tensioner including a ratchet mechanism, in which the retraction of a plunger is prevented by engagement of a rack formed on the plunger and a pawl pivoted on the ratchet housing.

Although in the embodiment described above, the air bubble evacuation groove is a straight groove extending axially along the outer peripheral surface of a cylindrical check valve unit, the evacuation groove can take other forms. For example, the groove can be in the form of a helix.

Additionally, although the tensioner described above is composed of a housing and a plunger as its principal parts, and the housing is adapted to be attached directly to an engine, the tensioner can be of the type in which an outer body is attached to an engine and contains the oil supply passage, and an inner body, which can be combined with the outer body, includes the tensioner housing having the plunger-accommodating hole, the plunger, and the check valve unit. This alternative structure makes it possible for the tensioner structure to be standardized, and adapted to various different engines by selection of a suitable outer body.

1. A hydraulic tensioner comprising:
a housing having a plunger-accommodating hole;
a plunger slidable in said plunger-accommodating hole, the plunger having a closed lower end protruding from said hole in a downward direction for applying tension to a traveling power transmission medium, and an open upper end within the hole, said plunger and the plunger-accommodating hole of the housing cooperating to form a high pressure oil chamber;
a plunger biasing spring accommodated in said high pressure oil chamber, and biasing the plunger in the protruding direction;
an oil supply passage in said housing, said oil supply passage communicating with the high pressure oil chamber for delivery of oil under pressure from an oil supply to said high pressure oil chamber; and
a check valve unit, disposed between the oil supply passage and the high pressure oil chamber, said check valve unit permitting oil to flow from the oil supply passage into the high pressure oil chamber but blocking reverse flow of oil from said high pressure oil chamber to the oil supply passage;
wherein said check valve unit comprises a ball seat having an opening communicating with said oil supply passage, a check ball movable into contact with said ball seat to close said opening, and away from said ball seat to allow flow of oil through said opening into the high pressure oil chamber, a ball-biasing spring urging said check ball toward the ball seat, and a retainer, positioning and supporting said ball-biasing spring, and limiting the movement of the check ball away from said ball seat;
said retainer having an interior space containing said ball and said ball-biasing spring and said ball seat fitting into said interior space, and said retainer also having an outer surface with a first end facing the high pressure oil chamber and a second end facing the oil supply passage, said first end being located at a level below the level of said second end; and
said retainer having an evacuation groove formed in its outer surface, the groove extending from said first end to said second end of the outer surface of the retainer, for releasing air bubbles from said high pressure oil chamber to the oil supply passage.
